(19) United States
(12) Patent Application Publication
(10) Pub. No.: US 2011/0313587 A1
(43) Pub. Date: Dec. 22, 2011

(54) Integrated Wireless Power Control Device

(75) Inventor: Wei Cheng Lin, Taipei City (TW)

(73) Assignee: UNIFIED PACKET SYSTEMS CORP., Taipei City (TW)

(21) Appl. No.: 12/828,544

(22) Filed: Jul. 1, 2010

Related U.S. Application Data
(62) Division of application No. 12/820,260, filed on Jun. 22, 2010.

(51) Int. Cl. G06F 1/28

(52) U.S. Cl. 700/296

(57) ABSTRACT

An integrated power control device and method are provided. In one embodiment, a device includes a body, a plurality of sockets for connection with a load, and a plurality of switch-controls each connected with corresponding one of the sockets and controlling power connecting to the load. The device further includes a microprocessor for the input, output, calculation and control of data and information flow, wherein the microprocessor issues commands to the switch-controls to execute switch on or off on the sockets, a timer, and a data storage unit for data storage so as to provide the microprocessor to access the data. A voltage-and-current detector detects voltage and current values and stores them into the data storage through the microprocessor. A voltage-current alerting unit receives the voltage values and current values and informs the microprocessor when the values exceed predetermined thresholds. Finally, a power computational unit calculates power consumption of the load.

### CROSS REFERENCE TO RELATED APPLICATIONS

This application is a divisional application of U.S. application Ser. No. 12/820,260, which was filed on Jun. 22, 2010, and is included herein by reference.

### FIELD OF THE INVENTION

This invention relates generally to a integrated wireless power control device and, particularly, though not exclusively, to one that is provided with features such as zero-watt standby switching, overload protection, wireless remote control, power consumption acquisition and display, and which allows electrical appliances to be more economical and to use less carbon, preferably with a guaranteed level of safety and quality energy management support.

### BACKGROUND OF THE INVENTION

In the daily life, an electric appliance load (for example, a TV set) has to keep its power ON during standby to enable the required remote control function. Under such circumstances, a typical electric appliance load will consume several tens of mA (milliampere) as per different designs. In other words, the average power consumption of an electric load is kept at a level of several watts up to some tens of watts during standby. Taking one watt into account, a thousand electrical appliance loads operating for an hour will consume one degree of standby electrical power. An ordinary family, on average, has four electrical appliances such as audio equipment, air conditioners, telephones and TV sets. This means that a million families will have four millions electrical appliance loads that will consume four thousand degrees of electrical power per hour, which means thirty five million degrees of electrical power over a year.

Given the present-day situation of serious electric power deficiencies, the power consumption brought about by standby modes is wasteful. Moreover, electrical power consumption gives rise to environmental issues such as increased carbon usage. Energy saving and carbon reduction are closely related. If energy saving is achieved, carbon usage is reduced.

One way to reduce standby power further is to switch-off the power connection to the electric load. Conventional wall switches and sockets, power extension cords and the majority of electrical appliances that serve direct circuit conduction have a limited capability for controlling the electric conduction of the load.

Generally, when electrical appliances are connected to a typical wall receptacle, there is no overload protection in the power line against surges of electric current which might seriously damage the electrical appliances. Typically, the only safety devices provided are circuit interrupters which are adapted to either open or burn out when a current overload is present for a predetermined time.

Conventionally, the circuit interrupters are located centrally, particularly in a domestic establishment, with at least one circuit interrupter having a capacity of approximately 15 or 20 amperes governing each circuit. The amperage capacity of the circuit interrupter may be excessive and afford little protection for an individual electrical device. For example, a load with a critical power rating below such a capacity may be damaged or may create damage if its rating is exceeded for an appreciable length of time. The circuit interrupters fail to adequately protect appliances because a current overload which might be less than that required to open or burn out the interrupter, and still great enough to cause damage, can flow through the circuit interrupter unimpeded.

In light of the aforesaid drawbacks, this invention present an integrated power control device with features such as zero-watt standby switching, overload protection, wireless remote control, power consumption acquisition, and which allows electrical appliances to be more economical and to use less carbon, preferably with a guaranteed level of safety and quality energy management support.

### SUMMARY OF THE INVENTION

The present invention relates to an integrated wireless power control device.

One aim of this invention is to provide an integrated power control device and more specifically to simultaneously provide features such as zero-watt standby switching, overload protection, wireless remote control, power consumption acquisition and display, which allows electric appliances to be used more economically and to use less carbon, for example to provide a guaranteed level of safety and quality energy management support.

The present invention is characterized primarily by providing a system architecture having densely integrated features, and also equipping the applied electric appliances with features such as zero-watt standby switching, overload protection, wireless remote control, power consumption acquisition/display and wireless assistance to help an administrator in the energy management of the system through a computer. By means of the densely integrated software and hardware of the circuit control system, the coveted target of power system administrators, namely to provide low cost, plain equipment implementing minute energy management can be achieved.

The system comprises a microprocessor, responsible for the input, output, computation and storage of the information flow and a voltage-and-current detector, including a detecting circuit for the standby electrical signals and a detecting circuit for regular loads. The detection circuit is used to acquire the electrical signals for regular and standby loads, and to send the information back to the microprocessor and a data storage unit. The sampled data is used to calculate the frequency of the electrical signals, threshold value for the voltage-current alerting unit, the time to trip loads by means of computation of the microprocessor using a specific predetermined algorithm to activate the countdown by a counting unit in order to disconnect the power connection to the loads. The data storage unit stores the acquired electrical signals of the loads and supports the microprocessor by offering temporary or permanent digital data swapping and storage space. A display driver module receives and interprets control signals from the microprocessor, and is arranged to display the real-time electrical signals: voltage, current, energy consumed, over voltage and over current status information etc. An alarm output module is provided for driving an alarm circuit in response to receiving overloaded triggers from the microprocessor. A voltage-current alerting unit works in real-time to see whether the value of the total voltage or current of the loads exceeds its corresponding threshold value. The associated microprocessor may smooth the samples to avoid unnecessary false alarms. The microprocessor may issue a control signal to switch controls to execute an ON/OFF switching action on the sockets to assure the basic system safety requirement. A voltage/current/power computation unit is provided for computing the consumed energy of the associated voltage/current values which can be displayed under the control of the microprocessor and the display driver module.

In order to achieve the goal of saving energy, an energy saving mode is provided as part of the design when all the loads are in standby. As long as the power consumptions of loads keep stably and small within predefined boundaries, the loads will be thus assumed to be in a “standby” state. The microprocessor will then command integrated wireless power control device to enter an energy saving mode to achieve the energy saving aim.

The invention will now be described, by way of example, with reference to the accompanying drawings as follows.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a function block diagram in accordance with a preferred embodiment of the present invention;

FIG. 1B is a schematic view of indirectly communicating with an integrated wireless power control device F located in a remote end of the present invention;

FIG. 2 is a flow chart indicating steps for tripping load using the function block diagram of FIG. 1;

FIG. 3 is a flow chart indicating steps for protection against the leakage current using the function block diagram of FIG. 1;

FIG. 4 is a flow chart indicating steps for load current control using the function block diagram of FIG. 1;

FIG. 5 is a flow chart indicating steps for over current protection using the function block diagram of FIG. 1;

FIG. 6 is a flow chart indicating steps for energy saving state of the MCU according the present invention; and

FIG. 7 is a schematic showing the power computation for zero-watt standby switching;

### DETAILED DESCRIPTION OF THE PREFERRED EMBODIMENTS

The present invention includes a body and a plurality of sockets on the body. The appearance of the present invention is similar to a typical wall receptacle, wall switches or power extension cords.

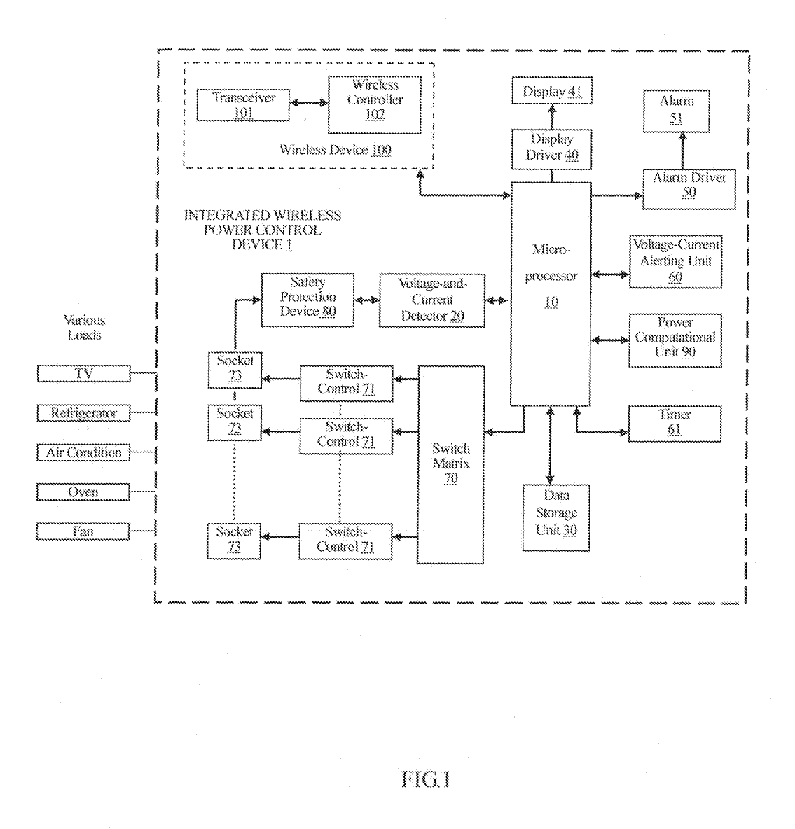

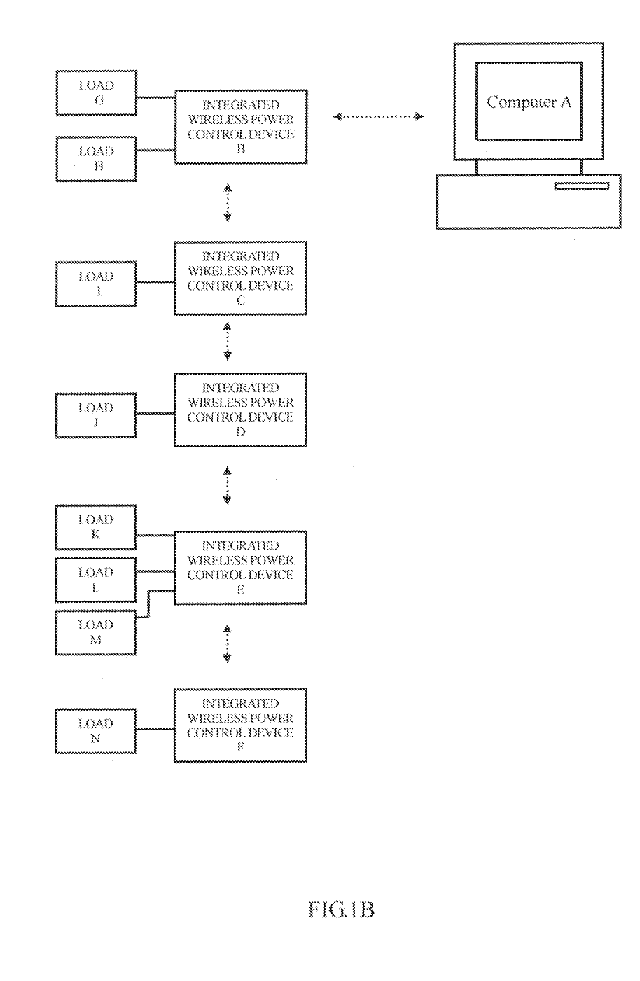

Please refer to FIG. 1, there is illustrated a functional block diagram of the present invention in accordance with a preferred embodiment of the integrated wireless power control device 1. A microprocessor (MCU) 10 is responsible for the input, output, computation and storage of associated data and information flow. The microprocessor 10 can be any digital data processing component, for instance an 8/16/32/64 bit processor, a field programmable gate array (FPGA) or a digital signal processor (DSP).

A voltage-and-current detector 20 is responsible for the acquisition of voltage and current signals of the total loads and for forwarding the signals to the microprocessor 10, a power computational unit 90 and a data storage memory unit 30 for temporary buffering or permanent storage. The detector 20 includes a detecting circuit for the standby electrical signals and a detecting circuit for regular loads.

The voltage-and-current detector 20 acquires the load voltage and current, and sends this out to the data storage unit 30. By means of a specific predetermined computational algorithm, the sampled frequency and threshold voltage/current value of each load are computed by the microprocessor 10. The microprocessor 10 keeps updating and refreshing the load signals through the voltage-and-current detector 20 for further continuing computation and decision making.

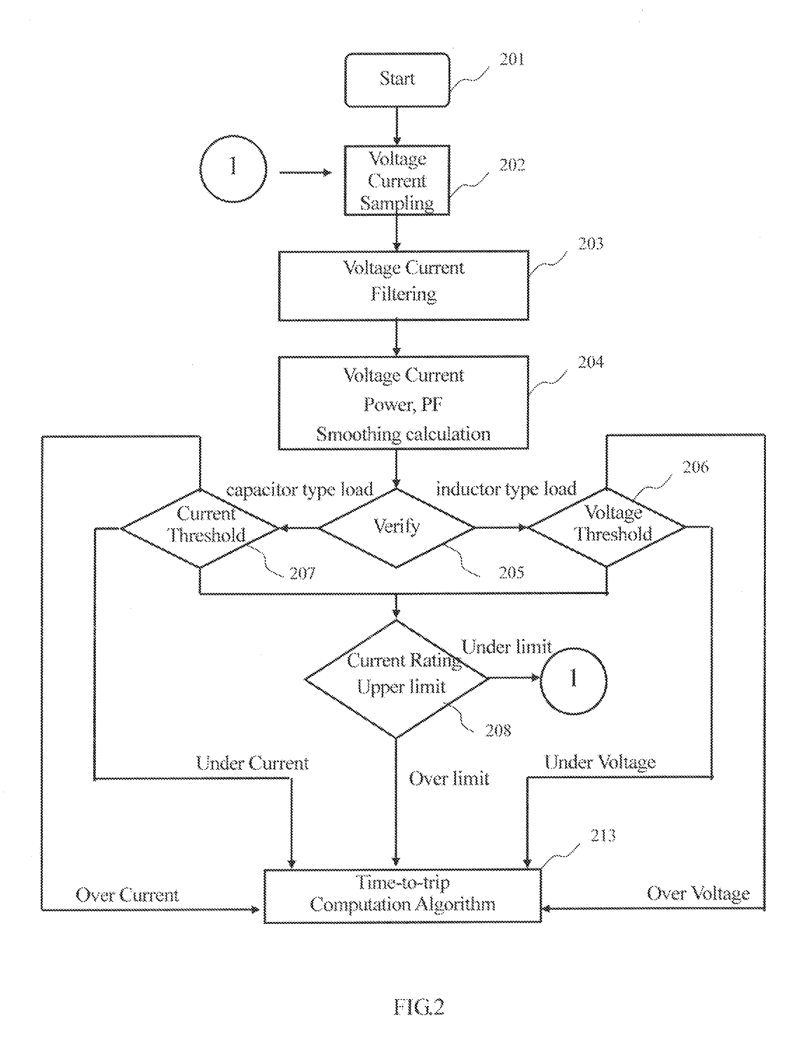

Please refer to FIG. 2 and FIG. 1, the operating frequency of the voltage and current signals is acquired by the steps 202,203 and 204: The voltage-and-current detector 20 samples the continuous electrical signals to become a sequence of discrete-time digital signals. The discrete-time digital signals are then filtered to eliminate the higher order harmonic portion and, in the end, are smoothed to reduce the quantization error. In step 204, the power and power factor are also calculated by the microprocessor 10 and power computational unit 90.

By the data calculated in the steps 203 and 204, the microprocessor 10 can verify whether the loads are inductive type or capacitive type by just the first ¼ cycle of the calculated voltage and current data in step 205. If the voltage leads the current, the decision step 205 goes to the step 206 and to verify whether the voltage threshold is exceeded or not in step 206 by the voltage-current alerting unit 60. If the current lead the voltage, the decision step 205 goes to the step 207 and to verify whether the current threshold is exceeded or not in step 207 by the voltage-current alerting unit 60. Once the voltage or current threshold is exceeded, the decision step 205 goes to the step 213 to calculate the time to trip the power connected to loads by the countdown of a timer 61.

If all the current and voltage values do not exceed the threshold and the current values are under a rating value by the step 208, the decision step goes to step 1 and then to step 202 to acquire new current and voltage data. If all the current and voltage values do not exceed the threshold by the step 208, but the current value is over the rating value, the decision step goes to step 213 to trip the power connected to loads by the countdown of a timer 61.

In the step 213, the computation algorithm including six conditions to calculate the time to trip loads:

1. Over voltage condition: The time to trip loads is T−o for over voltage protection and T−o=((1/(k3*(m3*V))⊕(1/k1*(m1*ln(h2*I)))), wherein the m1 and m3 are rating coefficients assignment, k1 and k3 are trip delayed time modifier, h2 is current coefficients, I is the detected current and V is the detected voltage. The symbol “⊕” in the T−o formula means choosing the smaller value between 1/(k3*(m3*V)) and 1/(k1*(m1*ln(h2*I))) to be the time of the over voltage condition to trip power.

2. Under voltage condition: The time to trip loads is T−u for over voltage protection and T−u=(1/(k4*(m4*V))⊙1/(k1*(m1*ln(h3*I)))), wherein the m1 and m4 are rating coefficients assignment, k1 and k4 are trip delayed time modifier, h3 is current coefficients, I is the detected current and V is the detected voltage. The symbol “⊙” in the T−u formula means choosing the bigger value between 1/(k3*(m3*V)) and 1/(k1*(m1*ln(h2*I))) to be the time of the under voltage condition to trip power.

3. Over current condition: The time to trip loads is T−1 for over current protection and T−1=1/(k1*m1*ln(h1*I)), wherein the m1 is rating coefficients assignment, k1 is trip delayed time modifier and I is the detected current.

4. Under current condition: The time to trip loads is T−i for under current protection and T−i=1/(k2*m2*I), wherein the m2 is rating coefficients assignment, k2 is trip delayed time modifier and I is the detected current.

5. Current over rating condition: The time to trip loads is T−f(V, I, PF, t) for current over rating but under threshold protection and T−f(V, I, PF, t)=1/(k0*V*I*PF), wherein the k0 is the trip delayed time modifier, PF is power factor, I is the detected current and V is the detected voltage.

6. Remote condition: When the wireless device 100 of FIG. 1 receives a command to trip the loads, the MCU 10 commends the switch controls 71 to disconnect the power connected to loads immediately.

The traditional trip load method for safety simply uses load current detected. This simple algorithm provides room to use easy-to-implement circuit designs. And the follow-up operation to trip the load is decided according to a current threshold value pre-assigned.

The drawback of using the single current to trip the loads can't satisfy the power consumption calculation needs. Even the additional circuitry added to complete the power consumption calculations, the simple pattern of fixed threshold decision-making to trip the load circuit lacks of application flexibility.

The time to trip loads algorithm of present invention is not a straight-forward thinking to cut off the load circuit by simply judging a threshold value but using more sophisticated logic operation to identify precisely the power consumption. And more over, a remote condition exists that interprets the control and management capability provided from far-side controllers. This far-side control offers either schedule plan or online supervising control capabilities which enhance the device control capabilities.

There are various ways available for the acquisition of electrical signals by the voltage-and-current detector 20 of FIG. 1 and big design discrepancies exist among such devices depending on their structural arrangements and safety considerations. The following techniques are briefly described and any one design can be used:

Data Acquisition Segment:

1. Isolated design. This design works by exploiting electrical and magnetic coupling to isolate the primary high voltage and the secondary low voltage. This can make use of a transformer to isolate the primary high voltage from the secondary low voltage for the acquisition of signals. This can also make use of semiconductors, for instance a hall sensor.

2. Non-isolated design. In this design, the primary high voltage and the secondary low voltage are connected in serious. This can make use of a semiconductor passive resistor element of both the primary high voltage and the secondary low voltage connected in serious, to acquire signals. This design can also make use of a semiconductor passive capacitance element. This design can also make use of a semiconductor passive inductance element, an active transistor element.

Packaging Design:

1. Standalone package type. Here, the voltage-and-current detector 20 and the microprocessor 10 are packed in the form of a standalone package. These two devices can be presented in a System on Chip (SoC) form, e.g. on a single IC device. The two devices can also be presented in a system in package (SiP) form.

2. Independent package type. Here, the voltage-and-current detector 20 and the microprocessor 10 are packed in the form of an independent package.

Please refer to FIG. 1, a data storage unit 30 for storing the acquired electrical signals and standby power for total loads through the voltage-and-current detector 20, also supports the microprocessor 10 by offering both temporary data swapping and permanent digital data storage space. The data storage unit 30 can be categorized into two types, as follows:

Space allocation type:

1. A standalone module, for instance packed into a RAM module alone.

2. A single package, with the same package of the microprocessor 10 having Flash and EEPROM.

Electrical Specifications:

1. Temporary storage, for instance a RAM module.

2. Permanent storage, for instance an EEPROM, a flash module, a removable CDROM, a HDD or other magnetic storage device.

A display driver 40 is connected to the microprocessor 10. The microprocessor 10 sends the sampled and/or calculated real-time electrical data of each load, namely the voltage, current, energy consumed and/or over-voltage and over-current signals to this display driver module 40. The display driver module 40 is responsible for the encoding and/or decoding of this output digital data to a display 41 (LCD/LED). The provided data includes such information as working voltage, current and frequency which makes the display 41 works as specified. It also takes display control signals from the microprocessor 10 to activate the display module.

An alarm driver 50 is arranged to drive an alarm 51 after receiving an alert signal from the microprocessor 10 such as in the event of an overload. The alarm driver 50 will be activated and will drive the alarm 51 under both normal and abnormal conditions. The types of alarm can be electrical (light, smog or audio signals) or can be simply a mechanical indication.

The voltage-current alerting unit 60 checks voltage and current of the loads in real-time. If the predetermined current or voltage threshold values are exceeded, the voltage-current alerting unit 60 will notify the microprocessor 10. The microprocessor 10 calculate the time to trip power and launch a countdown by the help of an associated timer unit 61 in order to decide the switch-off timing for protection against the over voltage and current. The associated microprocessor 10 may smooth the voltage and current to avoid unnecessary false alarms.

A optional switch matrix device 70 is arranged to receive a control signal from the microprocessor 10 when the wireless device 100 of FIG. 1 receives a command to trip power connected to a load or loads. The matrix device 70 decodes the associated control signal, and then outputs relevant control signals to a switch control 71 or switch controls 71. These devices are assigned and conduct a switch on or off action.

A safety protection device 80 is used with input terminals connected in series with the load IN line while the other, output, one is connected directly to the voltage-and-current detector 20 to provide a basic and overall protection to the entire system. The safety protection device 80 provides a comprehensive protection for the entire system by using the voltage-and-current detector 20 to sample each load signal, which signals are simultaneously sent to the data storage unit 30 of this system. The microprocessor 10 not only takes responsibility for storing the data, but works with the voltage-current alerting unit 60 and the timer unit 61, for protection against over voltage and current.

A power computational unit 90 is used to calculate the associated consumption of the power for loads (e.g. plug, TV, refrigerator, air conditioner, electric oven, electric fan and the like) and sends out the result by means of the predefined operation of the microprocessor 10 to the display driver 40 and the display unit 41.

A wireless device 100 comprises a remote wireless duplex transceiver 101 and a wireless controller 102. The remote control and management signals are transmitted and received by the wireless duplex transceiver 101 and the wireless controller 102. For instance, real-time supervision and control of the voltage, current and energy consumed can be performed through the wireless device 100 to help an administrator in the energy management of the system through a computer (or remote controller). These control and management signals are also conducted by the microprocessor 10 to carry out a wireless ON/OFF switching control over the socket 73 through the switch control 71.

Please refer to FIG. 1B, when the remote control and management signals sent by a computer A (or remote controller A) cannot be effectively and directly received by a integrated wireless power control device F located in a remote end, the remote control and management signals can be received and transmitted through other integrated wireless power control device from B,C,D and E, so as to indirectly transmit the wireless digital control signal to the integrated wireless power control device F located in the remote end. The integrated wireless power control device F can also send back status reports to the computer A indirectly by the help of other integrated wireless power control device B, C, D and E.

Please refer to FIG. 1B, when the wireless power control device B receives a remote control signal broadcasted from the computer A (or remote controller A), the wireless device 100 of the wireless power control device B send the control signal to the microprocessor 10 of the wireless power control device B to verify whether the wireless power control device B is the destination device for remote control signal or not. If the wireless power control device B is the destination device for the remote control signal, the microprocessor 10 of the wireless power control device B execute the remote control signal. If the wireless power control device B is the not destination device for the remote control signal, the microprocessor 10 of the wireless power control device B sends the remote control signal back to the wireless device 100 of the wireless power control device B to broadcast the control signal to the space. When any wireless power control device receive a remote control signal for the second time, the microprocessor 10 of the wireless power control device will drop the remote control signal and no further is action will be executed. In such way, a computer A (or a remote controller A) can indirectly communicate with an integrated wireless power control device F located in a remote end.

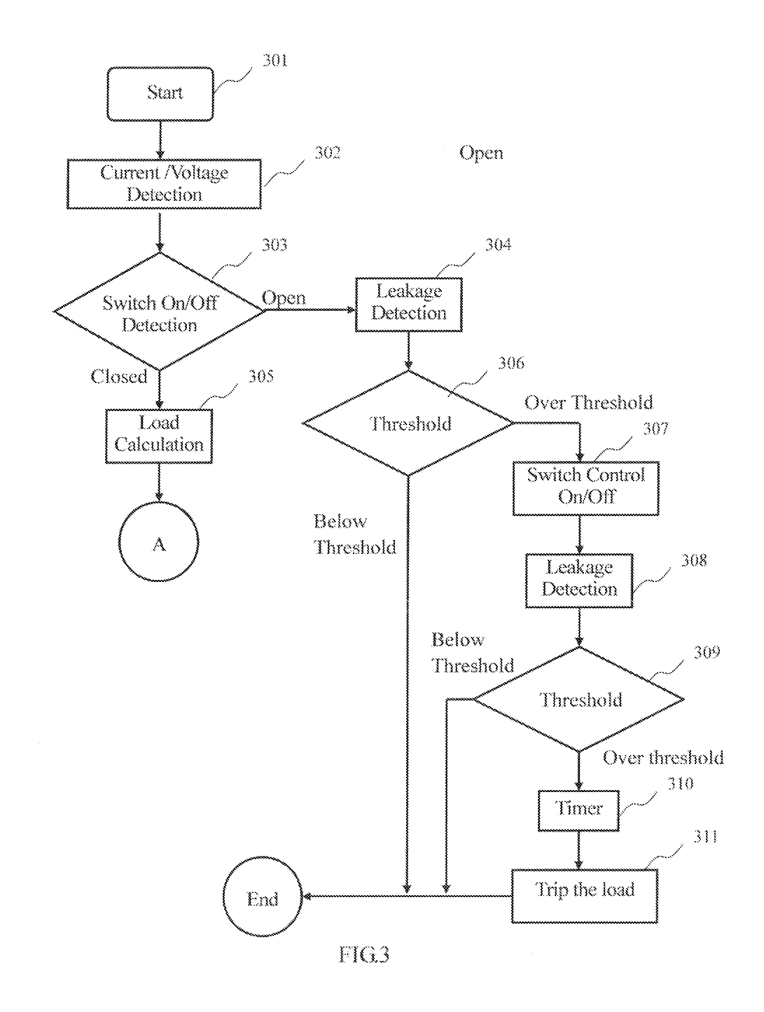

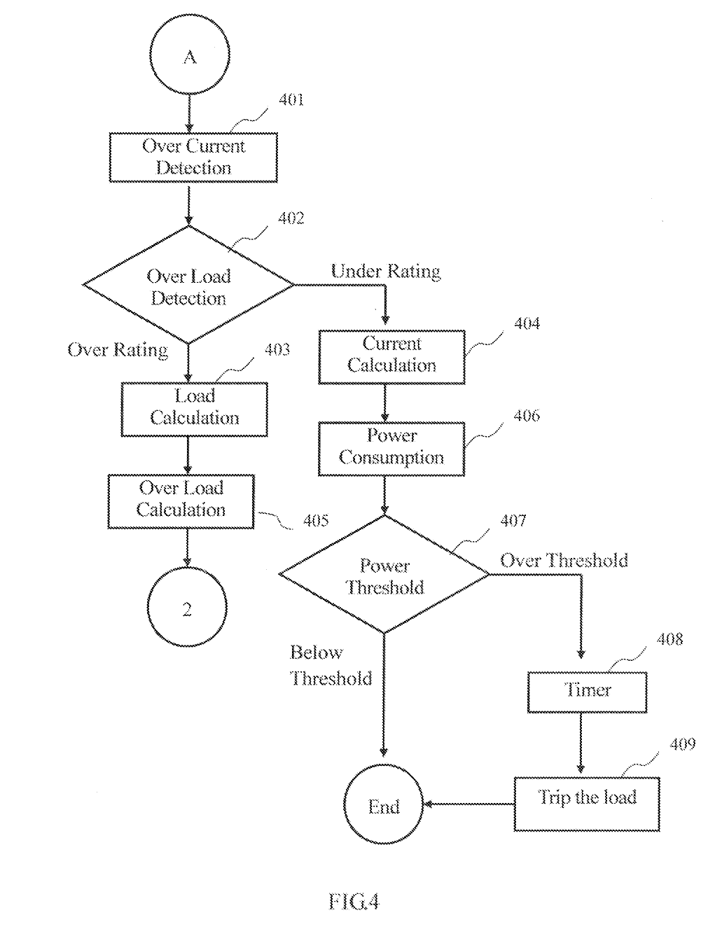

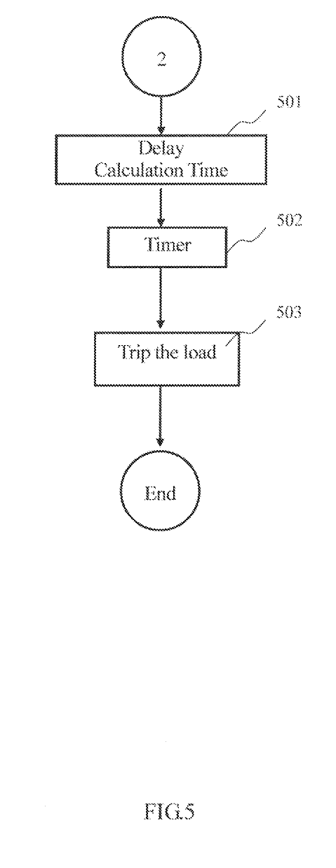

The flow chart of FIG. 3 is referred to in terms of explaining how protection against abnormal leakage current is achieved, with the flow chart of FIG. 4 relating to the manipulation of the normal load current, and the flow chart of FIG. 5 relating to the protection against over-current.

Please refer to FIG. 3 and FIG. 1, after acquiring the voltage or the current of the loads by the voltage-and-current detector 20 in step 302, the microprocessor 10 detects the switch control 71 On/Off statuses in step 303. If the switch control 71 is in an open status and the leakage current is over a minimum threshold value (step 304,306), the microprocessor 10 command the switch control 71 to switch on and off the relay of the socket 73 again (step 307). In the step 308, if the detected leakage current is still not below a low threshold value (step 308,309), the microprocessor 10 computes a delay time by the help of a timer 61 and shutdown a power connection to the loads on socket 73 by a upstream power switch after the delay time (step 310, 311).

Please refer to FIG. 3 & 4, if the switch control 71 is in closed status and the measured current is under rating (step 303, 305, 401, 402), the microprocessor 10 computes a delay time by the help of a timer 61 and shutdown a power connection to the loads through the corresponding switch control 71 after the delay time on condition that the power consumption value is over the predetermined value (by step 404, 406, 407, 408, 409).

Please refer to FIG. 4 & 5, if the measured current is over rating, the microprocessor 10 computes a delay time by the help of a timer 61 and shutdown a power connection to the loads through the corresponding switch control 71 after the delay time (by step 402, 403, 405, 501, 502, 503).

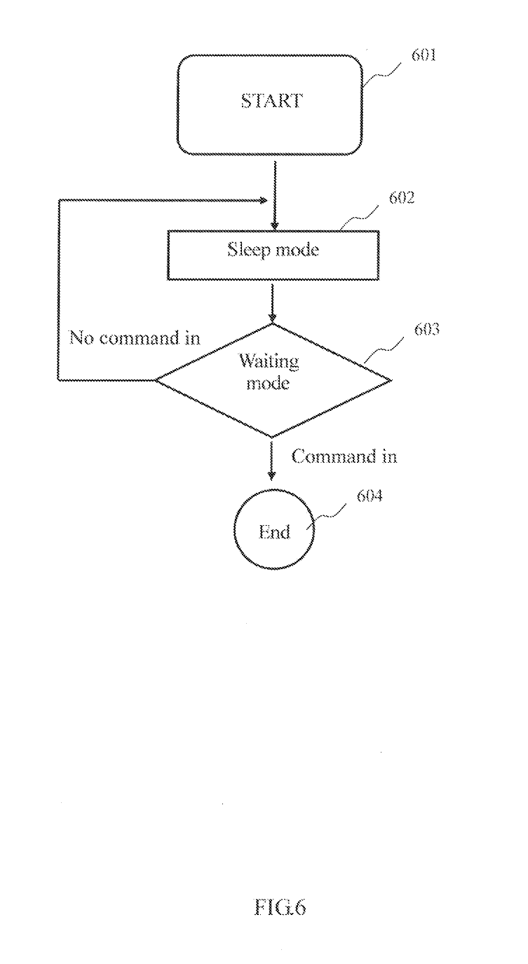

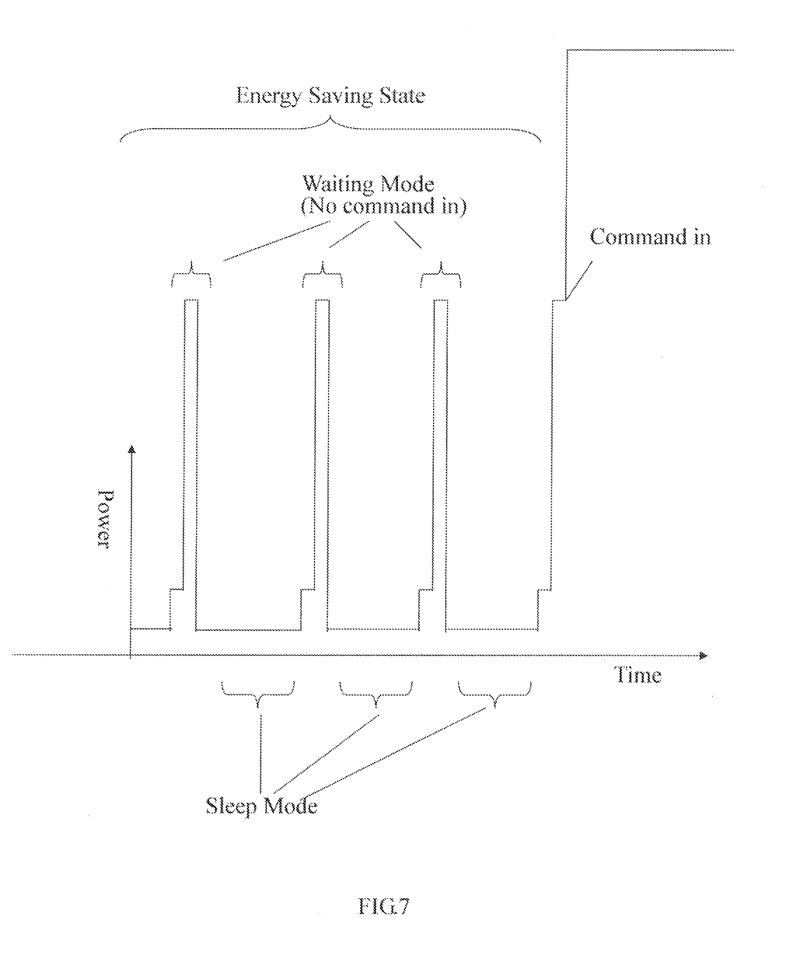

The proposed system provides such advantages over existing devices by integrating features for energy saving and zero-watt standby switching. As the sampled data is received, the calculated data is updated, and the deviation to the threshold value comparisons are also updated. As long as the power consumptions, for a predetermined span of time, keep small and stably within predefined boundaries and within defined constraints of idle power, it will be thus assumed to be in a “standby” state. The microprocessor 10 will then switch-off the socket 73 and command the system to enter an energy saving mode to achieve the energy saving aim. Please refer to FIG. 6 & FIG. 7, in the energy saving mode, the microprocessor 10 will stay in either a sleep or waiting mode. In the sleep mode, the integrated wireless power control device 1 consumes negligible power and only the timer 61 is active. The current consumed in the sleep mode is about 5 uA. After a predetermined period of time, the timer 61 wakes up the MCU 10 from the sleep mode into the waiting mode: The MCU 10 then activates the wireless device 100 for receiving commands. The current consumed in the waiting state is about 10 uA without the wireless device 100 activated and about 30 mA with the wireless device 100 activated. In the waiting state, the microprocessor 10 waits for any command from the wireless device 100 for about 30 ms. If the microprocessor 10 receives no command in the waiting state, the microprocessor 10 returns back to the sleep mode after the 30 ms waiting time. If the microprocessor 10 receives commands in the waiting state, the microprocessor 10 reacts according to the coming command and jumps out of the energy saving mode into a normal operating state.

It is known from the above description that this invention features zero-watt standby switching, overload protection, wireless remote control, power consumption acquisition/display and wireless assistance to help an administrator in energy management through a computer.

Although the present invention has been described with reference to the preferred embodiments thereof, it is apparent to those skilled in the art that a variety of modifications and changes may be made without departing from the scope of the present invention which is intended to be defined by the appended claims.

1-3. (canceled)

4. A method for zero-watt standby switching, comprising the steps of:
(a) providing a first integrated power control device, having:
a plurality of sockets, each provided for an electronic appliance connected thereto, and each of said sockets having a switching-control to switching said,
a microprocessor,
a timer connected with said microprocessor;
a wireless device connected with said microprocessor;
a voltage-and-current detector connected in between said microprocessor and said sockets,
a voltage-current alerting unit connected with said microprocessor, and
a power computational unit connected with said microprocessor;
(b) sending voltage signals and current signals detected by said voltage-and-current detector to said power computational unit to compute power values consumed by loads, said loads being said electronic appliance;
(c) sending said power value to said microprocessor;
(d) switching off said sockets and deactivating said integrated power control device except said timer into a first sleep mode by said microprocessor if said power values are small, which are stably within predefined boundaries, still said timer counting the time passed of said first sleep mode;
(e) activating said microprocessor and said wireless device after said time counted reaches a first predetermined time;
(f) switching on said sockets and deactivating said integrated power control device by said microprocessor if a wireless command is received by said wireless device, otherwise, deactivating said microprocessor and said wireless device except said timer into a second sleep mode by said microprocessor, still said timer counting the time passed of said second sleep mode and going back to the step (e).

5. The method for zero-watt standby switching according to claim 4, furthering comprising a second integrated power control device having elements the same as said first integrated power control device thereof, and said second integrated power control device and said first integrated power control device being coupled each other by wireless signals transmitted or received by the other integrated power control device.

6. The method for zero-watt standby switching according to claim 5, after said wireless command is broadcasting and received by said wireless device of said first integrated power control device, furthering comprising the steps of:
(g) sending said wireless command to said microprocessor of said first integrated power control device for analyzing said wireless command;
(h) ignoring said wireless command if said wireless command is received a second time;
(i) controlling the load corresponding of said first integrated power control device according to said wireless command, if the load is the target load indicated by said wireless command;
(j) broadcasting said wireless command by said wireless device of said first integrated power control device if none of loads of said first integrated power control device is the target load;
(k) received said wireless command by said wireless device of said second integrated power control device; and
(l) sending said wireless command to said microprocessor of said second integrated power control device for analyzing said wireless command;
(m) ignoring said wireless command if said wireless command is received a second time; and
(n) controlling the load corresponding of said second integrated power control device according to said wireless command, if the load is the target load indicated by said wireless command.
